(19) United States
(12) Patent Application Publication
(10) Pub. No.: US 2024/0365387 A1
(43) Pub. Date: Oct. 31, 2024

(54) SYSTEM AND METHOD FOR ESTIMATING RADIO COVERAGE OF A USER IN A NETWORK

(71) Applicant: Radisys India Private Limited, Bangalore (IN)

(72) Inventors: Saptarshi CHAUDHURI, Bengaluru (IN); Sree Charan Teja Reddy BUDAMA, Giddalur (IN); Narayanan RAVI, Chennai (IN); Shekar NETHI, Hyderabad (IN)

(73) Assignee: Radisys India Private Limited, Bangalore (IN)

(21) Appl. No.: 18/246,696

(22) PCT Filed: Feb. 8, 2023
(86) PCT No.: PCT/IB2023/051111

§ 371 Date: Mar. 27, 2023

(30) Foreign Application Priority Data
Feb. 8, 2022 (IN) 202241006590

(51) Int. Cl. H04W 74/0833; H04B 17/318; H04W 52/36; H04W 76/20

(52) U.S. Cl. CPC H04W 74/0833; H04B 17/328; H04W 52/365; H04W 76/20

(57) ABSTRACT

The present disclosure provides a system and a method for estimating radio coverage of a user in a wireless communication system. The system categorizes a user equipment (UE) into a cell edge, cell center, or a cell center coverage user based on the estimated radio coverage. The user may be categorized based on a timing advance, path loss of the UE calculated from power headroom report, and a reference signal received power (RSRP) reported by a user. Further, the system re-categorizes the UE based on an average RSRP and a timing advance defined in an observation interval.

### FIELD OF INVENTION

The embodiments of the present disclosure generally relate to systems and methods for categorization of user equipments in a wireless communication network. More particularly, the present disclosure relates to a system and a method for estimating radio coverage of a user in a network that categorizes the user equipment accurately.

### BACKGROUND OF INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Fifth generation (5G) technology is expected to fundamentally transform the role of technology in a telecommunication industry. Thus, a 5G wireless communication system is expected to support broad ranges of newly emerging applications in addition to the regular cellular mobile broadband services. The newly emerging applications or the services may be categorized into enhanced mobile broadband, massive deployment of Internet of Things (IoT), and ultra-reliable low latency communication systems. Using these services, video conference, television broadcast, and video on-demand (simultaneous streaming) applications with different types of multimedia services may be utilized by users. A radio resource management (RRM) module reserves certain radio resources that are common for a set of connected user equipments (UEs). For example, the RRM may reserve resources for a physical uplink control channel (PUCCH) to carry hybrid automatic repeat request (HARQ), scheduling request (SR), channel state information (CSI), and a control resource set (CORESET) to carry data centre interconnect (DCI). Certain PUCCH formats have good coverage compared to others and similarly physical downlink control channel (PDCCH) candidates with higher aggregation levels have better coverage compared to the lower aggregation levels. The PUCCH or CORESET configurations with higher coverage require more radio resources than the others.

The amount of radio resources reserved for PDCCH and PUCCH impact the system throughput in downlink (DL) and uplink (UL) transmissions. An approach of reserving resources for better coverage leads to increased overhead, whereas an aggressive approach leads to coverage problems. The RRM may optimize a number of resources to be reserved upon receiving information of radio coverage from the UEs. For example, a UE may be specified as a cell center UE or a cell edge UE. Based on the number of cell edge UEs and cell center UEs in the system, the RRM may find the optimal amount of common radio resources to be reserved that may improve the system's overall throughput performance.

US20110045831A1 describes a user grouping method for inter-cell interference coordination in mobile telecommunication systems. The user grouping method for inter-cell interference coordination technology uses handover information and measured data to group cell users into cell center users and cell edge users. In this method, a UE measures an average signal strength of a serving cell (G0) and neighbouring cells (G1—strongest neighbour cell). The UE determines if it should reply with the average signal strength information it measured and if it should initiate the inter-cell interference coordination measuring and response system dependent on the difference G0−G1. However, this method cannot be used for UE categorization before the first radio resource control (RRC) reconfiguration is sent because channel state interference (CSI) reporting configuration is not available at the UE at this stage. Even for the UE categorization after RRC reconfiguration, it is not possible for Open Distributed Unit (O-DU) to get L3 measurement information through an interface from Open centralized Unit (O-CU).

U.S. Pat. No. 8,078,185B2 describes a user group-based adaptive soft frequency reuse method to mitigate downlink interference among wireless cellular networks. The document describes a fractional frequency reuse (FFR) technique which includes reuse partition, power restriction, a dynamic user grouping, and a user group-based interference aware scheduler. In the dynamic user grouping, the users are classified into cell edge user groups, cell middle user groups, and cell center user groups. This method defines a metric, a degree of satisfaction (DOS), to differentiate users. DoS is relatively defined according to each user's quality of service (QOS) requirements and changes as the cell user moves or as traffic changes in the network. For example. DoS as user's throughput in full buffer traffic scenarios or delay in voice over internet protocol (VOIP) scenarios may be monitored. However, this method aims to mitigate inter-cell interference through frequency reuse among different UE categories. The methods in this document depend on geometry, signal to interference plus noise ratio (SINR), and a degree of satisfaction that are not available prior to a first RRC reconfiguration. Further, the document does not consider timing advance for a UE categorization.

EP3214882A1 discusses about determining a UE type and appropriately scheduling resources among different UE types from a partitioned bandwidth. However, the methods disclosed in this document use uplink (UL) SINR and L3 measurements for categorization that may not be available before the first RRC reconfiguration. Further, the document describes about determining the scheduling time of the UE through a reference signal received power (RSRP) difference from the UE. The document describes mutually orthogonal resources for cell edge and center users for managing inter cell interferences applicable for scheduling resources among different UEs.

There is, therefore, a need in the art to provide a system and a method that can mitigate the problems associated with the prior arts.

### OBJECTS OF THE PRESENT DISCLOSURE

Some of the objects of the present disclosure, which at least one embodiment herein satisfies are listed herein below.

An object of the present disclosure is to provide a system and a method to obtain a reference signal received power (RSRP) difference from a user equipment (UE).

An object of the present disclosure is to provide a system and a method to categorize the UE before a first radio resource control (RRC) reconfiguration is transmitted.

An object of the present disclosure is to provide a system and a method to facilitate an advanced categorization of the UE that dynamically re-categorizes the UE after the first RRC reconfiguration.

An object of the present disclosure is to provide a system and a method that categorizes the UE into a cell edge or a cell center UE before the first RRC reconfiguration using a timing advance of the UE and a path loss calculated from a power headroom (PHR).

An object of the present disclosure is to provide an observation period for averaging L1-RSRP of the UE and re-categorizing the UE based on the average RSRP and the timing advance after the observation period.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides a system for categorization of a user equipment (UE) in a network. The system may include a base station coupled to one or more processors. The one or more processors may be coupled with a memory that stores instructions to be executed by the one or more processors. The one or more processors may receive a timing advance of a UE from a detected physical random access channel (PRACH) of the UE and transmit one or more power headroom report (PHR) configuration parameters to the UE prior to a transmission of an initial radio resource control (RRC) reconfiguration. The one or more processors may receive a PHR report based on the transmitted one or more PHR configuration parameters and compute a path loss associated with the PHR report. The one or more processors may generate an initial categorization the UE based on an analysis of the received timing advance and the computed path loss of the UE. The one or more processors may upon on the transmission of the initial RRC reconfiguration, compute an average of a reference signal received power (RSRP) of the UE in an observation interval. The observation interval may be based on a varying velocity of the UE. The one or more processors may receive a latest timing advance of the UE based on the averaged RSRP. The one or more processors may generate an advanced categorization of the UE based on an analysis of the latest timing advance and the averaged RSRP.

In an embodiment, the one or more processors may be configured to utilize atleast one of a threshold path loss and a threshold timing advance, and perform the analysis of the received timing advance and the computed path loss of the UE to perform a first determination of whether the received timing advance is greater than the threshold timing advance. Further, in response to a positive first determination, the one or more processors may perform a second determination of whether the computed path loss is greater than the threshold path loss. Furthermore, in response to a positive second determination, the one or more processors may generate the initial categorization of the UE as a cell edge UE.

In an embodiment, in response to a negative second determination, the one or more processors may generate the initial categorization of the UE as a cell center UE.

In an embodiment, the one or more processors may be configured to utilize atleast a computed second path loss and perform the analysis of the received timing advance and the computed path loss of the UE to perform a third determination of whether the threshold path loss is greater than the computed second path loss, in response to a negative first determination and the positive second determination. Further, in response to a positive third determination, the one or more processors may generate the initial categorization of the UE as the cell edge UE. In response to a negative third determination, the one or more processors may generate the initial categorization of the UE as a cell center coverage UE.

In an embodiment, the one or more processors may compare the velocity of the UE with a computed threshold velocity to determine a duration of the observation interval.

In an embodiment, the one or more processors may initialize the observation interval based on the transmission of the initial RRC reconfiguration and compute the average of the RSRP of the UE at the end of the observation interval.

In an embodiment, the one or more processors may utilize at least one of a threshold RSRP and a threshold timing advance, and perform the analysis of the received latest timing advance and the averaged RSRP to perform a first determination of whether the received latest timing advance is greater than the threshold timing advance. The one or more processors may, in response to a positive first determination, perform a second determination of whether the averaged RSRP is lesser than the threshold RSRP. The one or more processors may, in response to a positive second determination, generate the advanced categorization of the UE as a cell edge UE.

In an embodiment, the one or more processors may, in response to the positive first determination and a negative second determination, generate the advanced categorization of the UE as a cell center UE. The one or more processors may, in response to a negative first determination and the negative second determination, generate the advanced categorization of the UE as the cell center UE.

In an embodiment, the one or more processors may compute a second threshold RSRP based on the threshold RSRP.

In an embodiment, the one or more processors may, in response to the positive second determination, perform a third determination of whether the averaged RSRP is lesser than the computed second threshold RSRP. The one or more processors may, in response to a positive third determination, generate the advanced categorization of the UE as the cell edge UE. The one or more processors may, in response to a negative third determination, generate the advanced categorization of the UE as a cell center coverage UE.

In an aspect, the present disclosure relates to a method for categorization of a UE in a network. The method may include receiving, by one or more processors, a timing advance of the UE from a detected PRACH and transmitting one or more PHR configuration parameters to the UE prior to a transmission of an initial RRC reconfiguration. The method may include receiving, by the one or more processors, a PHR report based on the transmitted one or more PHR configuration parameters and computing a path loss associated with the PHR report. The method may include generating, by the one or more processors, an initial categorization of the UE based on an analysis of the received timing advance and the computed path loss of the UE. The method may include upon the transmission of the initial RRC reconfiguration, computing, by the one or more processors, an average of an RSRP of the UE in an observation interval. The observation interval may be based on a varying velocity of the UE. The method may include receiving, by the one or more processors, a latest timing advance of the UE based on the averaged RSRP. The method may include generating, by the one or more processors, an advanced categorization of the UE based on an analysis of the latest timing advance and the averaged RSRP.

In an embodiment, the method may include utilizing, by the one or more processors, atleast one of a threshold path loss and a threshold timing advance, and performing the analysis of the received timing advance and the computed path loss of the UE for performing, by the one or more processors, a first determination of whether the received timing advance is greater than the threshold timing advance. The method may include, in response to a positive first determination, performing, by the one or more processors, a second determination of whether the computed path loss is greater than the threshold path loss. The method may include, in response to a positive second determination, generating, by the one or more processors, the initial categorization of the UE as a cell edge UE.

In an embodiment, the method may include generating, by the one or more processors, in response to a negative second determination, the initial categorization of the UE as a cell center UE.

In an embodiment, the method may include utilizing, by the one or more processors, atleast a computed second path loss and performing the analysis of the received timing advance and the computed path loss of the UE for, in response to a negative first determination and the positive second determination, performing, by the one or more processors, a third determination of whether the threshold path loss is greater than the computed second path loss. The method may include, in response to a positive third determination, generating, by the one or more processors, the initial categorization of the UE as the cell edge UE. In response to a negative third determination, the method may include generating, by the one or more processors, the initial categorization of the UE as a cell center coverage UE.

In an embodiment, the method may include comparing, by the one or more processors, the velocity of the UE with a computed threshold velocity to determine a duration of the observation interval.

In an embodiment, the method may include initializing, by the one or more processors, the observation interval based on the transmission of the initial RRC reconfiguration, and computing the average of the RSRP of the UE at the end of the observation interval.

In an embodiment, the method may include utilizing, by the one or more processors, atleast one of a threshold RSRP and a threshold timing advance, and performing the analysis of the received latest timing advance and the averaged RSRP for performing, by the one or more processors, a first determination of whether the received latest timing advance is greater than the threshold timing advance. The method may include, in response to a positive first determination, performing, by the one or more processors, a second determination of whether the averaged RSRP is lesser than the threshold RSRP. The method may include, in response to a positive second determination, generating, by the one or more processors, the advanced categorization of the UE as a cell edge UE.

In an embodiment, the method may include generating by the one or more processors, in response to the positive first determination and a negative second determination, the advanced categorization of the UE as a cell center UE. The method may include in response to a negative first determination and the negative second determination, generating by the one or more processors, the advanced categorization of the UE as the cell center UE.

In an embodiment, the method may include computing, by the one or more processors, a second threshold RSRP based on the threshold RSRP.

In an embodiment, the method may include performing, by the one or more processors, in response to the positive second determination, a third determination of whether the averaged RSRP is lesser than the computed second threshold RSRP. The method may include, in response to a positive third determination, generating, by the one or more processors, the advanced categorization of the UE as the cell edge UE. The method may include, in response to a negative third determination, generating, by the one or more processors, the advanced categorization of the UE as a cell center coverage UE.

In an aspect, the present disclosure relates to a UE for enabling categorization, where the UE may include one or more processors communicatively coupled to one or more processors of a base station. The one or more processors may be coupled to a memory that stores instructions to be executed by the one or more processors and causes the UE to transmit one or more queries to the one or more processors via a network. The one or more processors coupled to the base station may receive a timing advance of the UE from a detected PRACH of the UE and transmit one or more PHR configuration parameters to the UE prior to a transmission of an initial RRC reconfiguration. The one or more processors coupled to the base station may receive a PHR based on the transmitted one or more PHR configuration parameters and compute a path loss associated with the PHR report. The one or more processors coupled to the base station may generate an initial categorization the UE based on an analysis of the received timing advance and the computed path loss of the UE. The one or more processors coupled to the base station may upon the transmission of the initial RRC reconfiguration, compute an average of an RSRP of the UE in an observation interval. The observation interval may be based on a varying velocity of the UE. The one or more processors coupled to the base station may receive a latest timing advance of the UE based on the averaged RSRP. The one or more processors coupled to the base station may generate an advanced categorization of the UE based on an analysis of the latest timing advance and the averaged RSRP.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) of a proposed system, in accordance with an embodiment of the present disclosure.

FIG. 2 illustrates an exemplary block diagram (200) of a proposed system, in accordance with an embodiment of the present disclosure.

FIG. 3 shows an exemplary representation (300) of a single entry power head room report (PHR) medium access control (MAC) control element (CE), in accordance with an embodiment of the present disclosure.

FIG. 4 shows an exemplary flow diagram of a method (400) for saving parameters, in accordance with an embodiment of the present disclosure.

FIG. 5 shows an exemplary flow diagram of a method (500) for an initial user equipment (UE) categorization, in accordance with an embodiment of the present disclosure.

FIG. 6 shows an exemplary representation (600) of a timeline of observation intervals, in accordance with an embodiment of the present disclosure.

FIG. 7 illustrates an exemplary flow diagram of a method (700) for an advanced UE categorization, in accordance with an embodiment of the present disclosure.

FIG. 8 illustrates an exemplary computer system (800) in which or with which embodiments of the present disclosure may be implemented.

The foregoing shall be more apparent from the following more detailed description of the disclosure.

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

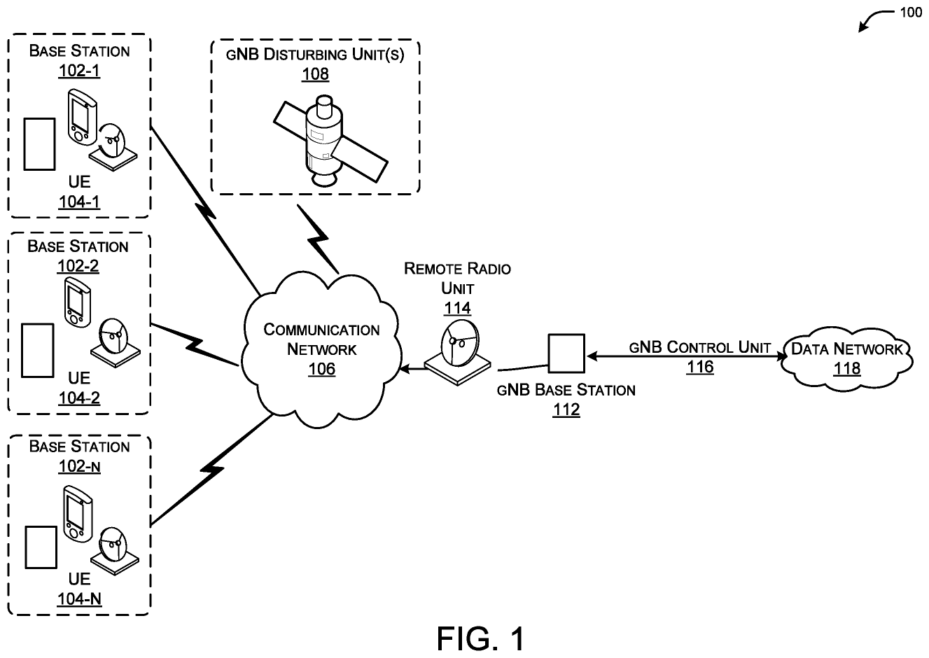

FIG. 1 illustrates an exemplary network architecture (100) of a proposed system, in accordance with an embodiment of the present disclosure.

As illustrated in FIG. 1, the network architecture (100) may include a base station (112) connected to one or more user equipments (104-1, 104-2 . . . 104-N) via a communication network (106). A person of ordinary skill in the art will understand that the one or more user equipments (104-1, 104-2 . . . 104-N) may be individually referred as the user equipment (UE) (104) and collectively referred as the user equipments (UEs) (104). Further, the base station (112) may also be referred as a gNB base station as illustrated in FIG. 1. The base station (112) may be connected to one or more base stations (102-1, 102-2 . . . 102-N) via a remote radio unit (114) and one or more gNB distributing unit(s) (108). Furthermore, the base station (112) may be communicatively coupled to a gNB control unit (116) to execute one or more control functions associated with the base station (112) and manage information received from a data network (118).

The UEs (104) may include, but not be limited to, a mobile, a laptop, etc. Further, the UEs (104) may include a smartphone, virtual reality (VR) devices, augmented reality (AR) devices, a general-purpose computer, desktop, personal digital assistant, tablet computer, and a mainframe computer. Additionally, input devices for receiving input from a user such as a touch pad, touch-enabled screen, electronic pen, and the like may be used. A person of ordinary skill in the art will appreciate that the UEs (104) may not be restricted to the mentioned devices and various other devices may be used.

The communication network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The communication network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the base station (112) may receive a timing advance of the UE (104) from a detected physical random access channel (PRACH) of the UE (104) and transmit one or more power headroom report (PHR) configuration parameters to the UE (104) prior to a transmission of an initial radio resource control (RRC) reconfiguration.

In an embodiment, the base station (112) may receive a PHR report based on the transmitted one or more PHR configuration parameters and compute a path loss associated with the PHR report.

In an embodiment, the base station (112) may generate an initial categorization of the UE (104) as a cell center UE or a cell edge UE, based on an analysis of the received timing advance and the computed path loss of the UE (104).

In an embodiment, the base station (112), upon the transmission of the initial RRC reconfiguration, may compute an average of a reference signal received power (RSRP) of the UE (104) in an observation interval. In an embodiment, the observation interval may be based on a varying UE velocity.

In an embodiment, the base station (112) may receive a latest timing advance of the UE (104) based on the averaged RSRP.

In an embodiment, the base station (112) may generate an advanced categorization of the UE (104) as the cell edge UE or the cell center UE, based on an analysis of the latest timing advance and the averaged RSRP.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

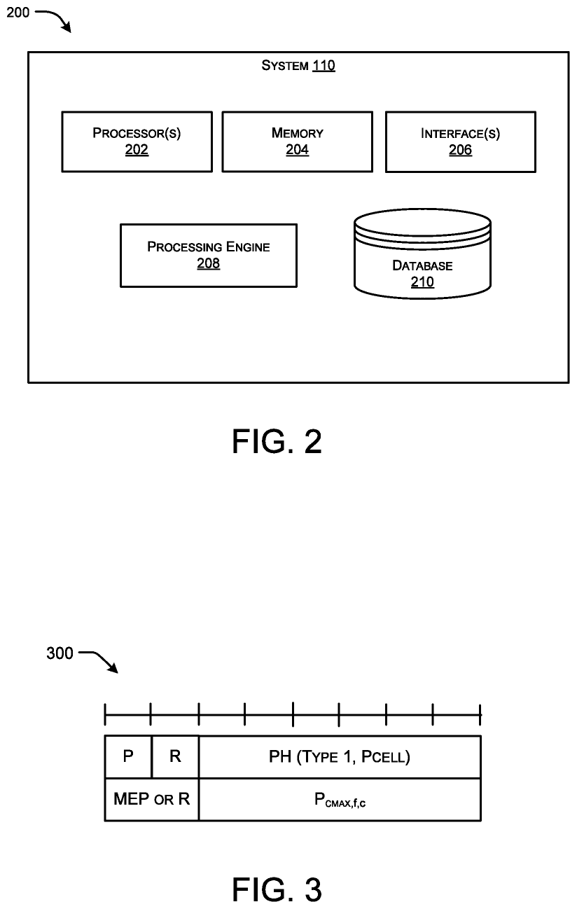

FIG. 2 illustrates an exemplary block diagram (200) of a proposed system, in accordance with an embodiment of the present disclosure.

Referring to FIG. 2, the base station (112) or the gNB base station (112) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the base station (112). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the base station (112) may include an interface(s) (206). The interface(s) (206) may comprise a variety of interfaces, for example, interfaces for data input and output (I/O) devices, storage devices, and the like. The interface(s) (206) may also provide a communication pathway for one or more components of the base station (112). Examples of such components include, but are not limited to, processing engine(s) (208) and a database (210)).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the base station (112) may comprise the machine-readable storage medium storing the instructions and the processing resource to execute the instructions, or the machine-readable storage medium may be separate but accessible to the base station (112) and the processing resource. In other examples, the processing engine(s) (208) may be implemented by electronic circuitry.

In an embodiment, the one or more processors (202) may receive a timing advance of the UE (104) from a detected PRACH of the UE (104) and transmit one or more power headroom report (PHR) configuration parameters to the UE (104) prior to a transmission of an initial RRC reconfiguration. The one or more processors (202) may receive a PHR report based on the transmitted one or more PHR configuration parameters and compute a path loss associated with the PHR report. The one or more processors (202) may generate an initial categorization the UE (104) based on an analysis of the received timing advance and the computed path loss of the UE (104). Further, the one or more processors (202) may upon the transmission of the initial RRC reconfiguration, compute an average of an RSRP of the UE (104) in an observation interval. The observation interval may be based on a varying UE velocity. The one or more processors (202) may receive a latest timing advance of the UE (104) based on the averaged RSRP. The one or more processors (202) may generate an advanced categorization of the UE (104) based on an analysis of the latest timing advance and the averaged RSRP.

In an embodiment, the one or more processors (202) may in response to a negative second determination, generate the initial categorization of the UE as a cell center UE.

In an embodiment, the one or more processors (202) may be configured to utilize atleast a computed second path loss and perform the analysis with the received timing advance and the computed path loss of the UE (104) to perform a third determination to determine whether the threshold path loss is lesser than the computed second path loss, in response to the negative first determination and positive second determination. The one or more processors (202) may in response to the positive third determination, generate the initial categorization of the UE (104) as a cell edge UE. In response to a negative third determination, the one or more processors (202) may generate the initial categorization of the UE (104) as the cell center coverage UE.

In an embodiment, the one or more processors (202) may compare the velocity of the UE (104) with a computed threshold velocity to determine a duration of the observation interval.

In an embodiment, the one or more processors (202) may initialize the observation interval based on the transmission of the initial RRC reconfiguration and compute the average of the RSRP of the UE (104) at the end of the observation interval.

In an embodiment, the one or more processors (20) may utilize at least one of a threshold RSRP and a threshold timing advance, and perform the analysis of the received latest timing advance and the averaged RSRP to perform a first determination of whether the received latest timing advance is greater than the threshold timing advance. The one or more processors (202) may in response to a positive first determination, perform a second determination of whether the averaged RSRP is lesser than the threshold RSRP. The one or more processors (202) may in response to a positive second determination, generate the advanced categorization of the UE (104) as a cell edge UE.

In an embodiment, the one or more processors (202) may in response to the positive first determination and a negative second determination, generate the advanced categorization of the UE (104) as a cell center UE. The one or more processors (202) may in response to a negative first determination and the negative second determination, generate the advanced categorization of the UE (104) as the cell center UE.

In an embodiment, the one or more processors (20) may compute a second threshold RSRP based on the threshold RSRP.

In an embodiment, the one or more processors (202) may in response to the positive second determination, perform a third determination of whether the averaged RSRP is lesser than the computed second threshold RSRP. The one or more processors (202) may in response to a positive third determination, generate the advanced categorization of the UE (104) as the cell edge UE. The one or more processors (220) may in response to a negative third determination, generate the advanced categorization of the UE (104) as a cell center coverage UE.

FIG. 3 shows an exemplary representation (300) of a single entry power head room report (PHR) medium access control (MAC) control element (CE), in accordance with an embodiment of the present disclosure. An ordinary person skilled in the art may understand that the UE (104) and the base station (112) described in FIG. 3 are referred from FIG. 1.

As illustrated in FIG. 3, the PHR reports a maximum output power (PCMAX) set by the UE (104) for its uplink (UL) transmissions. The power headroom (PH) for an actual physical uplink shared channel (PUSCH) transmission is calculated using the equation below,

$$PH = PC MAX - \{ PO \_ PUSCH + 10 * log 10 ( 2 µ * NPRB ) + α * PL + Δ + f \}$$

where, PO_PUSCH is the target receive power for 15 KHz physical resource block (PRB), μ is the sub-carrier spacing index, NPRB is the number of resource blocks (RBs) allocated for the PUSCH, α is the path loss compensation factor, Δ is the MCS related offset, and f is the closed loop offset adjustment. In the above equation, the path loss may be unknown at the base station (112) and it can be obtained from the equation.

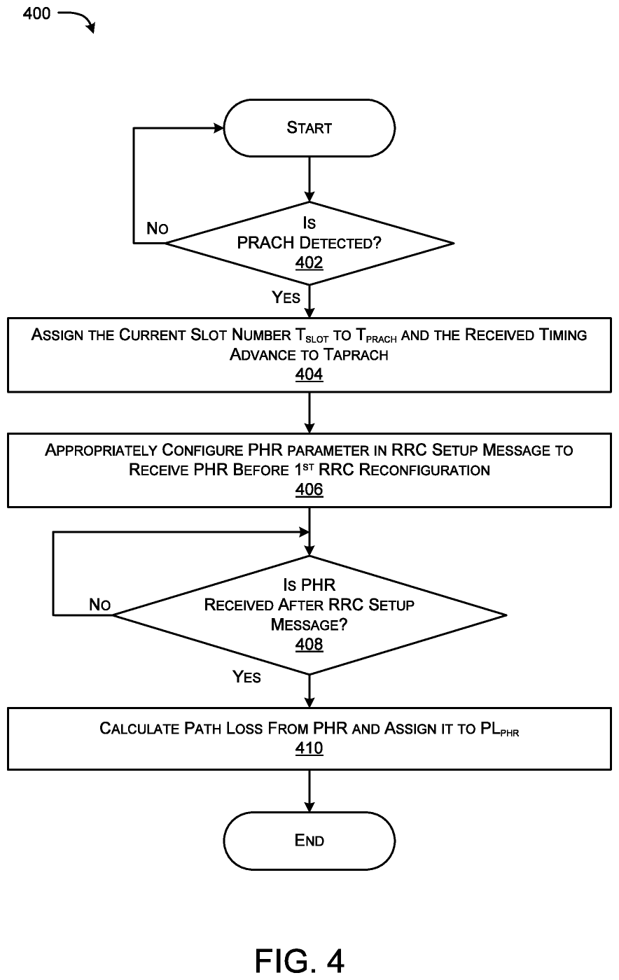

FIG. 4 shows an exemplary flow diagram of a method (400) for saving parameters, in accordance with an embodiment of the present disclosure. An ordinary person skilled in the art may understand that base station (112) described in FIG. 4 are referred from FIG. 1.

In an exemplary embodiment, the base station (112) may store the estimated timing advance of a user from the detected PRACH at step 402 into the TA_{PRACH} Variable.

At step 404, the base station (112) may assign the current slot number T_{SLOT} to T_{PRACH} and the received timing advance to TA_{PRACH}. The base station (112) may convey the appropriate PHR configuration parameters through RRC setup message at step 406 to obtain PHR report before the first RRC reconfiguration is transmitted. Then, the base station (112) may wait for the reception of PHR in the uplink (UL) after transmitting the RRC setup message at step 408. When PHR is received, the base station (112) may store the calculated path loss (PL) from the PHR received at step 410.

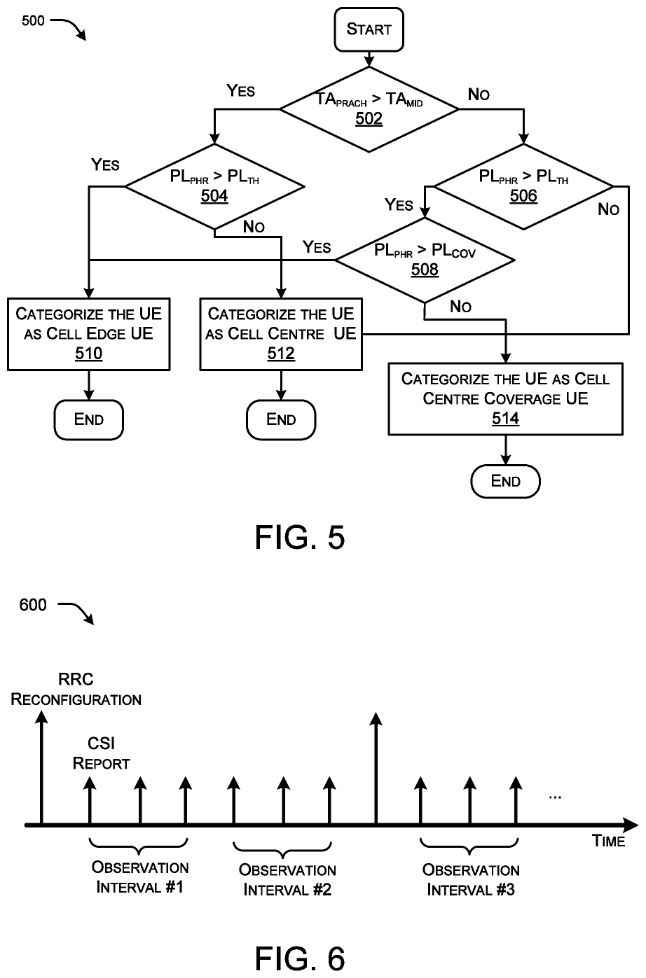

FIG. 5 shows an exemplary flow diagram of a method (500) for an initial user equipment (UE) categorization, in accordance with an embodiment of the present disclosure. An ordinary person skilled in the art may understand that the UE mentioned in FIG. 5 is similar to the UE (104) mentioned in FIG. 1

As illustrated in FIG. 5, a UE is categorized by combining the timing advance TA_{PRACH} from PRACH, and the path loss PL_{PHR} from PHR. The threshold for the timing advance parameter is TA_{mid}, which is provided by the operator network planner at step 502. The threshold for the path loss is PL_{TH}, which is derived from the DL RSRP threshold DL_RSRP_{TH} by using the following equation.

$$P {L}_{TH} = BS Tx power - DL \_ {RSRP}_{TH}$$

A UE geographically located in cell edge region i.e., TA_{PRACH} greater than TA_{mid} at step 502, is categorized as cell edge UE at step 510 when the power head room timing advance (TA_{PHR}) is greater than PL_{TH}. Now, for the UEs where TA_{PRACH} is less than PL_{TH} at step 512, the UE is categorized as a cell center UE. Further, when TA_{PHR} is lesser than PL_{TH} an additional check is incorporated to give an advantage for being in cell center region at step 506. Since the interference level is low at cell center region comparatively, an extra cushion may be provided for these UEs and they may be treated separately with a new category called “cell center coverage users” at step 514. For the cell center coverage users, a second path loss threshold PL_{COV} is defined at step 508 for categorization of the UEs with poor coverage inside cell center region. Here,

$$P {L}_{COV} = P {L}_{TH} + P {L}_{offset}$$

where, PL_{Offset} is a positive value configured based on the network requirements. When the PL_{PHR} is smaller than P_{LCOV}, the user is categorized as “cell center coverage UE,” otherwise categorized as a cell edge UE. This additional category “cell center coverage UE” may be treated as the cell center UE when categorization is not utilized for inter-cell interference management.

FIG. 6 shows an exemplary representation (600) of a timeline of observation intervals, in accordance with an embodiment of the present disclosure. An ordinary person skilled in the art may understand that the base station mentioned in FIG. 6 is similar to the base station (112) mentioned in FIG. 1.

As illustrated, in an aspect, after the transmission of first RRC reconfiguration, the base station (112) may acquire downlink (DL) measurement reports from the UE. One such parameter is an L1-RSRP, which can be periodically acquired from the UE through periodic channel state information (CSI) reports. The base station (112) may collect the L1-RSRP values from the UE over a period of an observation interval. The observation interval starts after each transmission of RRC reconfiguration message or after the end of one observation interval as shown in FIG. 6.

After the end of each observation interval, the base station (112) may calculate the linear average RSRP (RSRP_{avg}) from the L1-RSRP values collected during the observation interval. The observation interval may be dependent on the UE velocity. For a high velocity UE with velocity greater than a threshold velocity (V_{TH}), the observation interval may be smaller as the UE will be able to cover sufficient distance within the observation interval which may impact the timing advance. In case of a low speed UE with velocity lesser than V_{TH}, the observation interval may be greater than a high speed UE to provide sufficient time for estimating the status of the UE. For example, if the CSI report periodicity is 80 milliseconds (ms), then for a high speed UE, the observation interval may be 320 milliseconds (ms) and for a low speed UE, the observation interval may be 620 milliseconds (ms).

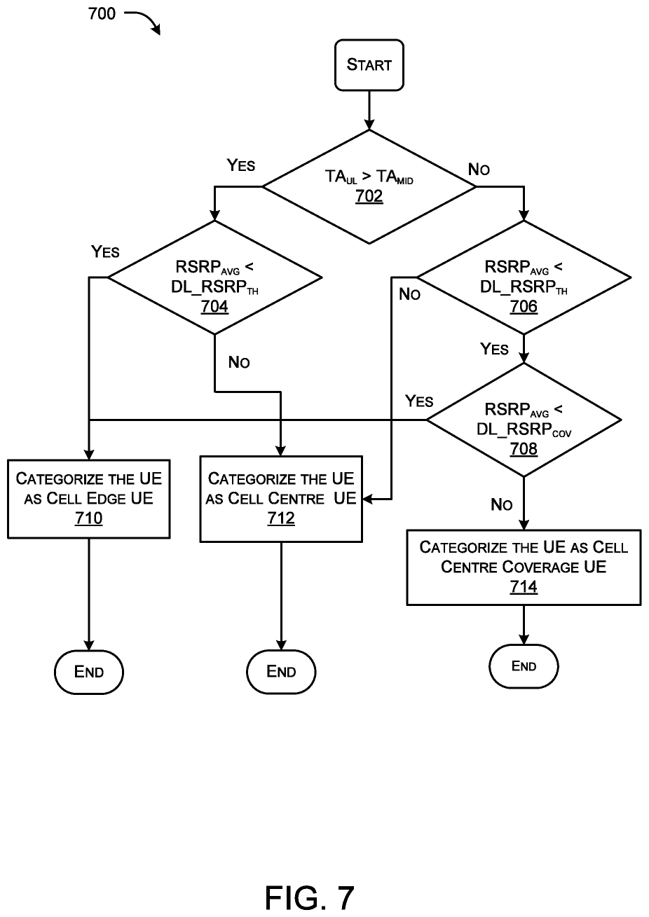

FIG. 7 illustrates an exemplary flow diagram of a method (700) for an advanced UE categorization, in accordance with an embodiment of the present disclosure. An ordinary person skilled in the art may understand that the base station mentioned in FIG. 7 is similar to the base station (112) mentioned in FIG. 1.

Apart from L1-RSRP, the base station (112) may have a latest timing advance (TA_{UL}) from a sounding reference signal (SRS)/PUSCH/PUCCH. Assuming that the TA_{UL} is valid at step 702, the categorization logic is similar to that of initial categorization, except that instead of using PL from PHR, RSRP_{avg} is used for the second categorization (also referred to as the advance categorization hereinafter) at steps 704, 706, and 708. Like the initial UE categorization, for the UEs with bad coverage and located in cell center region at step 712, a second threshold DL_RSRP_{COV} is used at step 708.

$$DL \_ {RSRP}_{COV} = DL \_ {RSRP}_{TH} - {RSRP}_{Offset}$$

Here, RSRP_{Offset} is a positive value and provides an extra advantage for the UEs with poor coverage and located in cell center region. An example value of RSRP_{Offset} may be 10 dB. The rationale behind using DL_RSRP_{COV} is same as that of PL_{COV} in the initial UE categorization logic mentioned in FIG. 5.

Specifically, the base station (112) may verify if TA_{UL}>T_{AMID} at step 702. Based on a positive first determination, the base station (112) may further verify if RSRP_{AVG}>DL_RSRP_{TH} at step 704. Based on a positive second determination, an advanced categorization of the UE (104) as a cell edge UE may be established at step 710 or the UE (104) may be categorized as a cell center UE at step 712. Similarly, the base station (112), on a negative first determination, (if TA_{UL}<T_{AMID}) at step 702, may perform a second determination to check whether RSRP_{AVG}<DL_RSRP_{TH} at step 706. Based on a positive second determination, the base station (112) may perform a third determination to check whether RSRP_{AVG}<DL_RSRP_{COV} at step 708. Based on a negative second determination, the UE (104) may be categorized as a cell center UE at step 712. Based on a positive third determination, the UE (104) may be categorized as a cell center coverage UE at step 714. Further, based on a negative third determination, the UE (104) may be categorized as the cell edge UE at step 710.

Further, if the category of the UE (104) is changed from the previous observation interval, the information may be conveyed to the RRM to take an appropriate action, for example to transmit the RRC reconfiguration. If the category remains similar to the previous observation interval, then the base station (112) may repeat the same procedure in the next observation interval.

Thus, the present disclosure provides a unique and efficient solution for categorization of a UE (104) into a cell edge UE, cell center UE, or a cell center coverage UE before the first RRC reconfiguration using the timing advance of the UE (104) and the path loss calculated from the power headroom reported by the UE (104). Also, the present disclosure relates to defining an observation period for averaging the L1-RSRP of the UE (104) and re-categorizing the UE (104) after the observation period based on the average RSRP and timing advance. The averaged RSRP may be utilized to further re-categorize the UE (104) into a cell edge UE, cell center UE, or a cell center coverage UE.

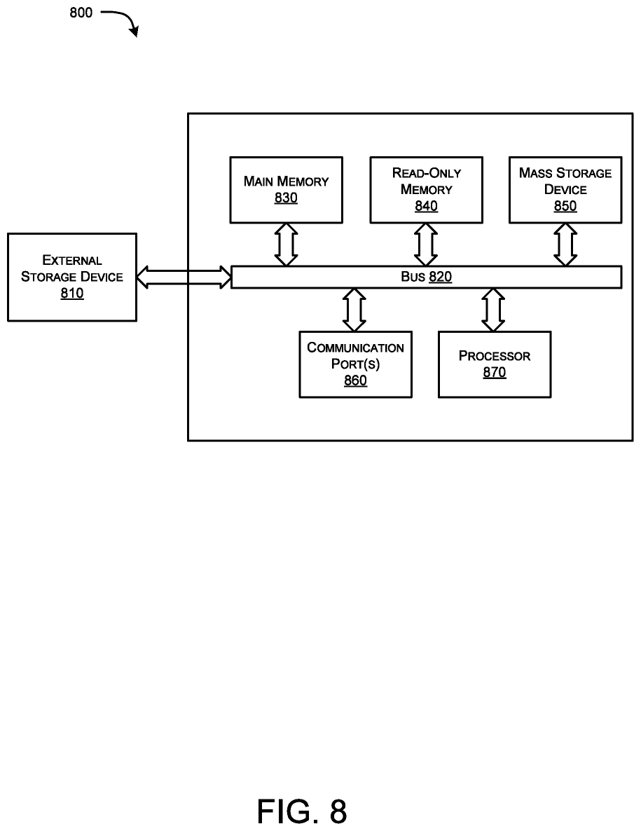

FIG. 8 illustrates an exemplary computer system (800) in which or with which the proposed system may be implemented, in accordance with an embodiment of the present disclosure.

As shown in FIG. 8, the computer system (800) may include an external storage device (810), a bus (820), a main memory (830), a read-only memory (840), a mass storage device (850), a communication port(s) (860), and a processor (870). A person skilled in the art will appreciate that the computer system (800) may include more than one processor and communication ports. The processor (870) may include various modules associated with embodiments of the present disclosure. The communication port(s) (860) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (860) may be chosen depending on a network, such as a Local Area Network (LAN), Wide Area Network (WAN), or any network to which the computer system (800) connects.

In an embodiment, the main memory (830)) may be Random Access Memory (RAM), or any other dynamic storage device commonly known in the art. The read-only memory (840) may be any static storage device(s) e.g., but not limited to, a Programmable Read Only Memory (PROM) chip for storing static information e.g., start-up or basic input/output system (BIOS) instructions for the processor (870). The mass storage device (850) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (820) may communicatively couple the processor(s) (870)) with the other memory, storage, and communication blocks. The bus (820)) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (870) to the computer system (800).

In another embodiment, operator and administrative interfaces. e.g., a display, keyboard, and cursor control device may also be coupled to the bus (820) to support direct operator interaction with the computer system (800). Other operator and administrative interfaces can be provided through network connections connected through the communication port(s) (860). Components described above are meant only to exemplify various possibilities. In no way should the aforementioned exemplary computer system (800) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method to obtain a reference signal received power (RSRP) difference from a user equipment (UE).

The present disclosure provides a system and a method to categorize the UE before a first radio resource control (RRC) reconfiguration is transmitted.

The present disclosure provides a system and a method to facilitate an advanced categorization of the UE that dynamically re-categorizes the UE after the first radio RRC reconfiguration.

The present disclosure provides a system and a method that categorizes the UE into a cell edge or a cell center UE before the first RRC reconfiguration using a timing advance of the UE and a path loss calculated from a power headroom report (PHR).

The present disclosure provides an observation period for averaging the L1-RSRP of the UE and re-categorizes the UE based on the average RSRP and the timing advance after the observation period.

We claim:

1. A system for categorization of a user equipment (UE) (104) in a network, the system comprising:
one or more processors (202) operably coupled to a base station (112); and
a memory (204) coupled with the one or more processors (202), wherein said memory (204) stores instructions which when executed by the one or more processors (202) causes the one or more processors (202) to:
receive a timing advance of the UE (104) from a detected physical random access channel (PRACH) of the UE (104) and transmit one or more power headroom report (PHR) configuration parameters to the UE (104) prior to a transmission of an initial radio resource control (RRC) reconfiguration;
receive a PHR report based on the transmitted one or more PHR configuration parameters and compute a path loss associated with the PHR report:
generate an initial categorization of the UE (104) based on an analysis of the received timing advance and the computed path loss of the UE (104);
upon the transmission of the initial RRC reconfiguration, compute an average of a reference signal received power (RSRP) of the UE (104) in an observation interval, wherein the observation interval is based on a varying velocity of the UE (104);
receive a latest timing advance of the UE (104) based on the averaged RSRP; and
generate an advanced categorization of the UE (104) based on an analysis of the latest timing advance and the averaged RSRP.

2. The system as claimed in claim 1, wherein the one or more processors (202) are configured to utilize at least one of: a threshold path loss and a threshold timing advance, and perform the analysis of the received timing advance and the computed path loss of the UE (104) to:
perform a first determination of whether the received timing advance is greater than the threshold timing advance;
in response to a positive first determination, perform a second determination of whether the computed path loss is greater than the threshold path loss; and
in response to a positive second determination, generate the initial categorization of the UE (104) as a cell edge UE.

3. The system as claimed in claim 2, wherein the one or more processors (202) are configured to:
in response to a negative second determination, generate the initial categorization of the UE (104) as a cell center UE.

4. The system as claimed in claim 2, wherein the one or more processors (202) are configured to utilize at least a computed second path loss, and perform the analysis of the received timing advance and the computed path loss of the UE (104) to:
in response to a negative first determination and the positive second determination, perform a third determination of whether the threshold path loss is greater than the computed second path loss;
in response to a positive third determination, generate the initial categorization of the UE (104) as the cell edge UE; and
in response to a negative third determination, generate the initial categorization of the UE (104) as a cell center coverage UE.

5. The system as claimed in claim 1, wherein the one or more processors (202) are configured to compare the velocity of the UE (104) with a computed threshold velocity to determine a duration of the observation interval.

6. The system as claimed in claim 1, wherein the one or more processors (202) are configured to initialize the observation interval based on the transmission of the initial RRC reconfiguration, and compute the average of the RSRP of the UE (104) at the end of the observation interval.

7. The system as claimed in claim 1, wherein the one or more processors (202) are configured to utilize at least one of: a threshold RSRP and a threshold timing advance, and perform the analysis of the received latest timing advance and the averaged RSRP to:
perform a first determination of whether the received latest timing advance is greater than the threshold timing advance;
in response to a positive first determination, perform a second determination of whether the averaged RSRP is lesser than the threshold RSRP; and
in response to a positive second determination, generate the advanced categorization of the UE (104) as a cell edge UE.

8. The system as claimed in claim 7, wherein the one or more processors (202) are configured to:
in response to the positive first determination and a negative second determination, generate the advanced categorization of the UE (104) as a cell center UE; and
in response to a negative first determination and the negative second determination, generate the advanced categorization of the UE (104) as the cell center UE.

9. The system as claimed in claim 7, wherein the one or more processors (202) are configured to compute a second threshold RSRP based on the threshold RSRP.

10. The system as claimed in claim 9, wherein the one or more processors (202) are configured to:
in response to the positive second determination, perform a third determination of whether the averaged RSRP is lesser than the computed second threshold RSRP;
in response to a positive third determination, generate the advanced categorization of the UE (104) as the cell edge UE; and
in response to a negative third determination, generate the advanced categorization of the UE (104) as a cell center coverage UE.

11. A method for categorization of a user equipment (UE) (104) in a network, the method comprising:
receiving, by one or more processors (202), a timing advance of the UE (104) from a detected physical random access channel (PRACH) and transmitting one or more power headroom report (PHR) configuration parameters to the UE (104) prior to a transmission of an initial radio resource control (RRC) reconfiguration;
receiving, by the one or more processors (202), a PHR report based on the transmitted one or more PHR configuration parameters and computing a path loss associated with the PHR report;
generating, by the one or more processors (202), an initial categorization of the UE (104) based on an analysis of the received timing advance and the computed path loss of the UE (104);
upon the transmission of the initial RRC reconfiguration, computing, by the one or more processors (202), an average of a reference signal received power (RSRP) of the UE (104) in an observation interval, wherein the observation interval is based on a varying velocity of the UE (104);
receiving, by the one or more processors (202), a latest timing advance of the UE (104) based on the averaged RSRP; and
generating, by the one or more processors (202), an advanced categorization of the UE (104) based on an analysis of the latest timing advance and the averaged RSRP.

12. The method as claimed in claim 11, comprising utilizing, by the one or more processors (202), atleast one of: a threshold path loss and a threshold timing advance, and performing the analysis of the received timing advance and the computed path loss of the UE (104) for:
performing, by the one or more processors (202), a first determination of whether the received timing advance is greater than the threshold timing advance;
in response to a positive first determination, performing, by the one or more processors (202), a second determination of whether the computed path loss is greater than the threshold path loss; and
in response to a positive second determination, generating, by the one or more processors (202), the initial categorization of the UE (104) as a cell edge UE.

13. The method as claimed in claim 12, comprising generating, by the one or more processors (202), in response to a negative second determination, the initial categorization of the UE (104) as a cell center UE.

14. The method as claimed in claim 12, comprising utilizing, by the one or more processors (202), atleast a computed second path loss, and performing the analysis of the received timing advance and the computed path loss of the UE (104) for:
in response to a negative first determination and the positive second determination, performing, by the one or more processors (202), a third determination of whether the threshold path loss is greater than the computed second path loss;
in response to a positive third determination, generating, by the one or more processors (202), the initial categorization of the UE (104) as the cell edge UE; and
in response to a negative third determination, generating, by the one or more processors (202), the initial categorization of the UE (104) as a cell center coverage UE.

15. The method as claimed in claim 11, comprising comparing, by the one or more processors (202), the velocity of the UE (104) with a computed threshold velocity to determine a duration of the observation interval.

16. The method as claimed in claim 11, comprising initializing, by the one or more processors (202), the observation interval based on the transmission of the initial RRC reconfiguration, and computing the average of the RSRP of the UE (104) at the end of the observation interval.

17. The method as claimed in claim 11, comprising utilizing, by the one or more processors (202), atleast one of: a threshold RSRP and a threshold timing advance, and performing the analysis of the received latest timing advance and the averaged RSRP for:
performing, by the one or more processors (202), a first determination of whether the received latest timing advance is greater than the threshold timing advance;
in response to a positive first determination, performing, by the one or more processors (202), a second determination of whether the averaged RSRP is lesser than the threshold RSRP; and
in response to a positive second determination, generating, by the one or more processors (202), the advanced categorization of the UE (104) as a cell edge UE.

18. The method as claimed in claim 17, comprising:
generating, by the one or more processors (202), in response to the positive first determination and a negative second determination, the advanced categorization of the UE (104) as a cell center UE; and
generating, by the one or more processors (202), in response to a negative first determination and the negative second determination, the advanced categorization of the UE (104) as the cell center UE.

19. The method as claimed in claim 17, comprising computing, by the one or more processors (202), a second threshold RSRP based on the threshold RSRP.

20. The method as claimed in claim 19, comprising:
performing, by the one or more processors (202), in response to the positive second determination, a third determination of whether the averaged RSRP is lesser than the computed second threshold RSRP;
generating, by the one or more processors (202), in response to a positive third determination, the advanced categorization of the UE (104) as the cell edge UE; and
generating, by the one or more processors (202), in response to a negative third determination, the advanced categorization of the UE (104) as a cell center coverage UE.

21. A user equipment (UE) (104) for enabling categorization, the UE (104) comprising:
one or more processors communicatively coupled to one or more processors (202) of a base station (112), wherein the one or more processors are coupled to a memory, and wherein said memory stores instructions which when executed by the one or more processors cause the UE (104) to:
transmit one or more queries to the one or more processors (202) via a network (116),
wherein the one or more processors (202) are configured to:
receive a timing advance of the UE (104) from a detected physical random access channel (PRACH) of the UE (104) and transmit one or more power headroom report (PHR) configuration parameters to the UE (104) prior to a transmission of an initial radio resource control (RRC) reconfiguration;
receive a PHR report based on the transmitted one or more PHR configuration parameters and compute a path loss associated with the PHR report;
generate an initial categorization of the UE (104) based on an analysis of the received timing advance and the computed path loss of the UE (104);
upon the transmission of the initial RRC reconfiguration, compute an average of a reference signal received power (RSRP) of the UE (104) in an observation interval, wherein the observation interval is based on a varying velocity of the UE (104);
receive a latest timing advance of the UE (104) based on the averaged RSRP; and
generate an advanced categorization of the UE (104) based on an analysis of the latest timing advance and the averaged RSRP.
